(19) United States
(12) Patent Application Publication
(10) Pub. No.: US 2008/0153378 A1
(43) Pub. Date: Jun. 26, 2008

(54) METHOD OF FORMING BARRIER RIBS

(76) Inventors: Shunsuke FUJIO, Miyazaki (JP); Takashi Yoshinaga, Kunitomi (JP)

Correspondence Address: MILES & STOCKBRIDGE PC, 1751 PINNACLE DRIVE, SUITE 500, MCLEAN, VA, 22102-3833, US

(21) Appl. No.: 11/963,827

(22) Filed: Dec. 22, 2007

(30) Foreign Application Priority Data
Dec. 26, 2006 (JP) 2006-349798

(51) Int. Cl. H01J 9/02

(52) U.S. Cl. 445/24

(57) ABSTRACT

A method of forming barrier ribs includes the following steps. The first step is to form a barrier rib material layer on a substrate. The second step is to form a resist film on the barrier rib material layer. The third step is to form the barrier rib material layer into a barrier rib pattern material layer. The fourth step is to remove the resist film from the barrier rib pattern material layer. The fifth step is to fire the barrier rib pattern material layer to form barrier ribs. In the above steps, a bonding layer is formed between the substrate and the barrier rib material layer. The bonding layer has such a bonding strength that sufficiently maintains the barrier rib pattern material layer on the substrate upon removing the resist film from the barrier rib pattern material, and is made from a thermally burning-out material that is burned out upon firing the barrier rib pattern material layer.

### CROSS-REFERENCE TO RELATED APPLICATION

This application is related to Japanese application No. 2006-349798, filed on Dec. 26, 2006, whose priority is claimed under 35 USC §119, the disclosure of which is incorporated by reference in its entirety.

### BACKGROUND OF THE INVENTION

1. Field of the Invention

The present invention relates to a method of forming barrier ribs, and more specifically relates to a method of forming barrier ribs having processes in which, after forming a barrier rib pattern material layer through a patterning process by using a resist mask, the resist mask is removed from the barrier rib pattern material layer.

2. Description of the Related Art

Plasma display panels (hereinafter, referred to as a “PDP”) have been known as display panels having barrier ribs, and among these, AC surface-discharge-type PDP's have been well known. These PDP's have a structure in which a substrate on a front face side and a substrate on a back face side are bonded to each other, with a discharge gas being sealed inside thereof. A plurality of display electrodes are formed on an inner face of the substrate on the front face side in parallel with one another, and these display electrodes are covered with a dielectric layer and a protective layer. Barrier ribs, used for dividing a discharge space, are formed on the substrate on the back face side, and phosphor layers of three primary colors, that is, red (R), green (G) and blue (B), are formed between the barrier ribs in a divided manner through coating processes.

When a voltage is applied between a pair of adjacent display electrodes, a discharge occurs in a discharge space divided by the barrier ribs, and ultraviolet rays are generated by the discharge so that a color display is performed by exciting the phosphor layers to emit light by the ultraviolet rays. Here, upon forming the barrier ribs, a subtracting method, such as a sand blasting method and an etching method, has been widely used (for example, see Japanese Published Unexamined Patent Application No. HEI 2(1990)-301934).

In barrier rib forming processes using the sand blasting method, first, a barrier rib material layer is formed on a substrate, and this barrier rib material layer is laminated with a photosensitive dry film or coated with a liquid-state photosensitive resist, and this is then subjected to exposing and developing processes so that a resist mask for a barrier rib pattern is formed.

After removing the barrier rib material layer exposed from the resist mask (barrier rib pattern mask) by sand blasting, the resist mask is washed and removed by using a peeling solution to form a barrier rib pattern material layer. Then, the barrier rib pattern material layer is fired so that barrier ribs are formed.

Thus, in the barrier rib forming processes by using the sand blasting method, a cutting process used for blowing cutting particles to the barrier rib material layer exposed from the resist mask and a removing process used for removing the resist mask after the cutting process are inevitably required.

In the resist mask removing process, however, a problem arises in which the barrier rib material layer to be left as the barrier rib pattern tends to collapse to cause a defect. This problem becomes more conspicuous as image quality with higher precision is achieved and a width of the barrier ribs becomes narrower, with a higher aspect ratio being achieved.

### SUMMARY OF THE INVENTION

The present invention, which has been devised to solve these problems, is provided with processes in which a bonding layer, which is made to be burned out upon firing the barrier rib pattern material layer, is formed between the substrate and the barrier rib material layer so that it becomes possible to prevent the barrier rib pattern material layer from collapsing even at the time of removing the resist mask.

The method of forming barrier ribs of the present invention is provided with the steps of: forming a barrier rib material layer on a substrate; forming a resist film on the barrier rib material layer to pattern the resist film into a barrier rib pattern; removing the barrier rib material layer corresponding to unnecessary portions by utilizing the patterned resist film, to form a barrier rib pattern material layer; removing the resist film from the barrier rib pattern material layer; and firing the barrier rib pattern material layer to form barrier ribs, wherein a bonding layer is formed between the substrate and the barrier rib material layer, and the bonding layer has such a bonding strength that sufficiently maintains the barrier rib pattern material layer on the substrate upon removing the resist film from the barrier rib pattern material, and is made from a thermally burning-out material which is burned out when the barrier rib pattern material layer is fired.

In accordance with the present invention, it becomes possible to prevent the barrier ribs from collapsing at the time of removing the resist mask, and consequently to reduce the defective product rate of the barrier ribs. Moreover, when the present invention is applied to a method for manufacturing a display panel, a display panel with higher precision can be produced since no collapsing of the barrier ribs occurs even when the width of the barrier ribs is narrowed.

### BRIEF DESCRIPTION OF THE DRAWINGS

FIG. 1(a) and FIG. 1 (b) are explanatory views that show one example of a PDP manufactured by using a method of forming barrier ribs in accordance with the present invention.

FIG. 2(a) to FIG. 2(g) are explanatory views that show the method of forming barrier ribs of the present invention in the order of processes.

### DESCRIPTION OF THE PREFERRED EMBODIMENTS

The method of forming barrier ribs of the present invention is mainly characterized in that a process for patterning barrier ribs is carried out, with a thermally burning-out bonding layer mainly composed of a resin being formed between a formation face for a barrier rib material layer and the barrier rib material layer. The bonding layer is formed by using such a material as to withstand a thermal treatment upon drying the barrier rib material layer and also as to be burned out together with a binder component in the barrier rib material at the time of a firing process after a patterning process.

The method of forming barrier ribs of the present invention, which is suitably used for the patterning process by the sand blasting method, may also be used for a chemical etching method including a peeling process of a resist mask. Moreover, the PDP to be used as the subject of the present invention is not only an AC surface-discharge-type PDP, but also a DC-type PDP, and the present invention may be applied to a PDP with barrier ribs formed on a substrate on the front face side as well as to a PDP with barrier ribs formed on both of the substrates on the front face side and the back face side.

In the present invention, examples of the substrate include a substrate made from glass, quartz, ceramics or the like, and a substrate on which desired components, such as electrodes, an insulating film, a dielectric layer and a protective film, are formed.

The electrodes may be formed by using various known materials and methods known in the corresponding field. Examples of materials to be used for the electrodes include a transparent conductive material, such as ITO and SnO₂, and a metal conductive material, such as Ag, Au, Al, Cu and Cr. Various known methods in the corresponding field may be adopted as the method for forming the electrodes. For example, a thick-film forming technique, such as printing, may be used, or a thin-film forming technique, such as a physical deposition method or a chemical deposition method, may be used. With respect to the thick-film forming technique, for example, a screen-printing method is used. With respect to the physical deposition method for the thin-film forming technique, a vapor deposition method and a sputtering method may be used. With respect to the chemical deposition method, a thermal CVD method, a photo CVD method, or a plasma CVD method may be used.

In the present invention, the barrier rib material layer can be formed by using various known materials and methods in the corresponding field. For example, a paste-state barrier rib material made from glass flit, a binder resin, a solvent and the like is used, and this barrier rib material is applied by using a screen printing method and dried thereon so that the barrier rib material layer is formed.

The resist film can be formed by using various known materials and methods in the corresponding field. For example, a photosensitive dry film resist is used, and by laminating this photosensitive dry film, the resist film can be formed. Alternatively, a liquid-state photosensitive resist is used, and by applying this photosensitive resist through a known coating method, the resist film can be formed. The patterning process of the resist film may be carried out by using any one of various known methods in the corresponding field, such as a photolithographic method.

Not limited to the PDP, the present invention may be applied to methods for manufacturing all kinds of panels, as long as the panel relates to a method of forming barrier ribs in which, after a barrier rib pattern material layer has been formed through patterning by using a resist mask, the resist mask is removed from the barrier rib pattern material layer.

With respect to the method of forming barrier ribs, that is, the method of forming barrier ribs in which, after a barrier rib pattern material layer has been formed through patterning by using a resist mask, the resist mask is removed from the barrier rib pattern material layer, for example, a method of forming barrier ribs by using a subtracting method, such as a subtracting method and a wet-etching method, is used.

In the case when the sand blasting method is used, cutting particles are blasted onto a barrier rib material layer on which a resist mask is formed, and unnecessary portions for the formation of barrier ribs are removed from the barrier rib material layer; thereafter, the resist mask is washed and removed by using a peeling solution to form a barrier rib pattern material layer, and the barrier rib pattern material layer is fired so that barrier ribs can be formed. Moreover, in the case when the wet-etching method is used, a barrier rib material layer with a resist mask formed thereon is immersed in an etching solution or washed by an etching solution so that the barrier rib material layer corresponding to unnecessary portions is removed, and the resist mask is then washed and removed by using a peeling solution to form a barrier rib pattern material layer, and the barrier rib pattern material layer is fired so that barrier ribs can be formed.

The method of forming barrier ribs of the present invention is in particular desirably used upon forming barrier ribs having a width of 100 μm or less.

Any bonding layer may be used as long as it is formed between the substrate and the barrier rib material layer, has such a bonding strength as to sufficiently maintain the barrier rib material layer on the substrate upon removing the resist film from the barrier rib material layer and is made from a thermally burning-out material that is burned out when the barrier rib pattern material layer is fired.

This bonding layer is preferably made from a material mainly composed of a heat resistant resin that is not burned out at least up to 200° C. More specifically, the bonding layer is preferably made from a material mainly composed of one or two or more kinds of synthetic resins selected from the group consisting of a polyether-based resin, a polyimide-based resin, polycarbonate, poly 4-ethylene fluoride and polyphenylene sulfide. The bonding layer is preferably designed to have a thickness of 10 μm or less.

The following description will discuss the present invention in detail based upon embodiments shown in Figures; however, the present invention is not intended to be limited by these, and various modifications may be made therein.

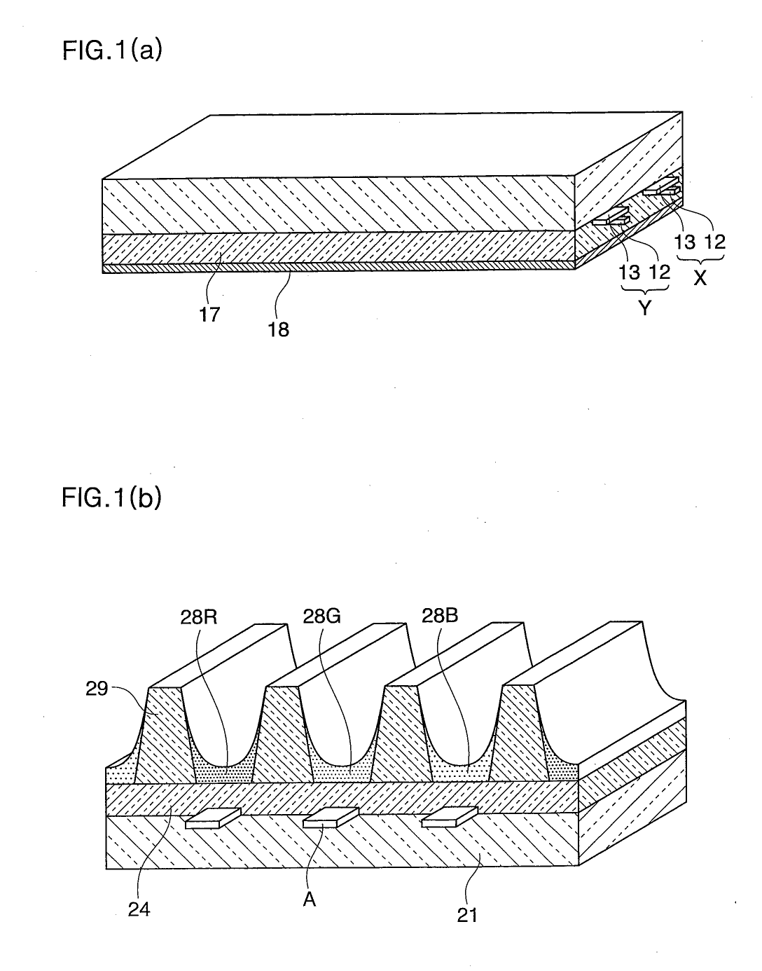

FIG. 1(a) and FIG. 1(b) are views that explain one example of a PDP manufactured by using the method of forming barrier ribs of the present invention, and FIG. 1(a) is a partially exploded perspective view showing a substrate on the front face side, and FIG. 1(b) is a partially exploded perspective view showing a substrate on the back face side. The PDP in accordance with this embodiment is an AC surface-discharge-type PDP for color display.

The PDP is configured by a substrate 11 on the front face side on which components that allow functions as the PDP are formed and a substrate 21 on the back face side. Glass substrates are used for the substrates 11 and 21 on the front face side and the back face side, and in addition to the glass substrate, for example, a quartz substrate and a ceramic substrate may be used.

On the inner face of the substrate 11 on the front face side, display electrodes X and display electrodes Y are alternately placed in a horizontal direction with equal intervals. The display electrodes X are discharge sustaining electrodes, and the display electrodes Y are scanning electrodes. All the gaps between the adjacent display electrodes X and display electrodes Y form display lines L. Each of the display electrodes X and Y is configured by a transparent electrode 12, made from ITO, SnO₂ or the like, having a wide width, and a bus electrode 13, made of metal, such as Ag, Au, Al, Cu, and Cr, and a laminated body thereof (for example, a laminated structure of Cr/Cu/Cr), having a narrow width. Upon forming these display electrodes X and Y, a thick-film-forming technique such as a screen-printing process is used for Ag and Au, and a thin-film-forming technique, such as a vapor deposition method and a sputtering method, and an etching technique are used for the other materials so that a desired number of electrodes having desired thickness, width and gap can be formed. Hereinafter, the display electrode X is referred to also as the X electrode, and the display electrode Y is referred to also as the Y electrode.

Here, in the present PDP, a PDP having a so-called ALIS structure in which display electrodes X and display electrodes Y are placed with equal intervals, with each gap between the adjacent display electrode X and display electrode Y being allowed to form a display line L, has been exemplified; however, the present invention may also be applied to a PDP having a structure in which paired display electrodes X and Y are placed separately with a distance (non-discharge gap) in which the paired display electrodes X and Y generate no discharge.

On the display electrodes X and Y, a first dielectric layer 17 is formed in a manner so as to cover the display electrodes X and Y. This first dielectric layer 17 is formed by processes in which a glass paste, made from glass flit, a binder resin and a solvent, is applied onto a substrate 11 on the front face side by using a screen-printing method and fired thereon. The dielectric layer 17 may also be formed by film-forming a SiO₂ film thereon by using a plasma CVD method.

A protective film 18, used for protecting the dielectric film 17 from damage due to collision of ions generated by discharge upon display, is formed on the dielectric layer 17. This protective film 18 is made from MgO. The protective film may be formed by using a known thin-film forming process in the corresponding field, such as an electron beam vapor deposition method and a sputtering method.

On the inner face of the substrate 21 on the back face side, a plurality of address electrodes A are formed in a direction intersecting with the display electrodes X and Y on the plan view, and a second dielectric layer 24 is formed in a manner so as to cover the address electrodes A. The address electrodes A, which generate an address discharge used for selecting cells to emit light at intersections with the display electrodes Y, are formed into a three-layer structure of Cr/Cu/Cr. In addition to this structure, these address electrodes A may also be formed by using another material, such as Ag, Au, Al, Cu and Cr.

In the same manner as in the display electrodes X and Y, upon forming these address electrodes A, a thick-film-forming technique such as a screen-printing process is used for Ag and Au, and a thin-film-forming technique, such as a vapor deposition method and a sputtering method, and an etching technique are used for the other materials so that a desired number of electrodes having desired thickness, width and gap can be formed. The second dielectric layer 24 can be formed by using the same method and the same material as those of the first dielectric layer 17.

Barrier ribs 29 having a linear shape, which divide the discharge space in the column direction, are formed on the second dielectric layer 24 placed between the adjacent address electrodes A. Here, the barrier ribs 29 may have a lattice shape, for example, referred to as box ribs, waffle ribs, mesh-shaped ribs. The barrier ribs 29 may be formed by using a method, such as a transferring method, a sand blasting method, a printing method and a photosensitive paste method. For example, in the transferring method, a transfer intaglio having concave portions corresponding to the barrier rib shape is used, and a glass paste, made from glass flit, a binder resin, a solvent and the like, is injected into the concave portions of the transfer intaglio, and transferred onto the substrate 21, and this is then fired to form barrier ribs. In the sand blasting method, a glass paste, made from glass flit, a binder resin, a solvent and the like, is applied onto the second dielectric layer 24 and dried thereon, and cutting particles are then blasted onto the glass paste layer, with a cutting mask having openings corresponding to the barrier rib pattern being attached thereto, so that the glass paste layer exposed to the openings of the mask is cut off, and the glass paste layer thus cut off is fired to form the barrier ribs. Moreover, in the photosensitive paste method, in place of the cutting process by the use of the cutting particles, a photosensitive resin is used as the binder resin, and after exposing and developing processes by the use of a mask, a firing process is carried out thereon to form the barrier ribs.

On the side faces and bottom face inside an elongated groove formed between the adjacent barrier ribs 29, phosphor layers 28R, 28G and 28B, which are excited by ultraviolet rays to generate visible rays of red (R), green (G) and blue (B), are formed. Each of the phosphor layers 28R, 28G and 28B is formed through processes in which phosphor paste containing phosphor powder, a binder resin and a solvent is applied to the inside of the groove between the barrier ribs 29 by using a screen printing process, a method using a dispenser or the like, and after this process has been repeated for each of the colors, a firing process is carried out thereon. These phosphor layers 28R, 28G and 28B may also be formed through a photolithographic technique by using a sheet-shaped phosphor layer material (so-called green sheet) containing phosphor powder, a photosensitive material and a binder resin. In this case, a sheet having a desired color is affixed onto the entire face of a display area on the substrate 21, and the sheet is subjected to exposing and developing processes; thus, by repeating these processes for each of the colors, phosphor layers having the respective colors are formed in the corresponding cell (groove) between the barrier ribs.

The PDP is manufactured through processes in which the substrate 11 on the front face side and the substrate 21 on the back face side, described above, are aligned face to face with each other in a manner so as to allow the display electrodes X, Y and address electrodes A to intersect with each other, and the peripheral portion thereof is then sealed, with a discharge space surrounded by the barrier ribs 29 being filled with a discharge gas formed by mixing Xe and Ne. The sealing pressure of the discharge gas is about 66.4 kPa (500 Torr). In this PDP, a discharge space in each of the intersections between the display electrodes X, Y and the address electrodes A forms one cell (unit light-emitting area), that is, the minimum unit for display. One pixel is configured by three cells of R, G and B. Here, the present invention can be applied to a PDP having a lattice cell structure having longitudinal barrier ribs dividing the discharge space in a column direction and lateral barrier ribs dividing the discharge space in a row direction.

In the above-mentioned PDP, the pixel array of the full HD standard includes 1080 pixels in the longitudinal direction and 1920 pixels in the lateral direction, and supposing that the pixel structure is a lateral array structure of three cells of R, G and B, the number of cells in the lateral direction corresponds to 5760 pcs.

In an attempt to realize this cell array by using a laterally elongated screen at a ratio of 9 to 16 (longitudinal side to lateral side), with 42 inches in the diagonal length, since the effective screen size corresponds to 920 mm in horizontal length and 518 mm in vertical length, the cell pitch in the lateral direction is 159 μm, and with respect to the longitudinal barrier ribs used for dividing these cells, those barrier ribs having a bottom width of 100 μm or less are inevitably required.

In an attempt to obtain a resolution in an XGA level in a large screen of about 55 inches in the diagonal dimension, since the barrier rib is allowed to have a bottom width of about 130 μm, no problem arises even when the barrier ribs are patterned by using a normal sand blasting method. However, upon processing the barrier ribs with a bottom width of 100 μm or less, the patterning process of the barrier ribs causes a problem of collapse of the barrier rib patterning material layer in a mask peeling process for removing a resist mask from the barrier rib patterning material layer because the bonding strength between the patterned barrier rib material layer in an unfired state (barrier rib patterning material layer) and the dielectric layer is weak, making it difficult to form barrier ribs with high precision.

Here, the above-mentioned bottom width of the barrier ribs refers to the width of a barrier rib measured at a position of 20% of the height of the barrier rib from the surface of the second dielectric layer of the substrate on the back face side.

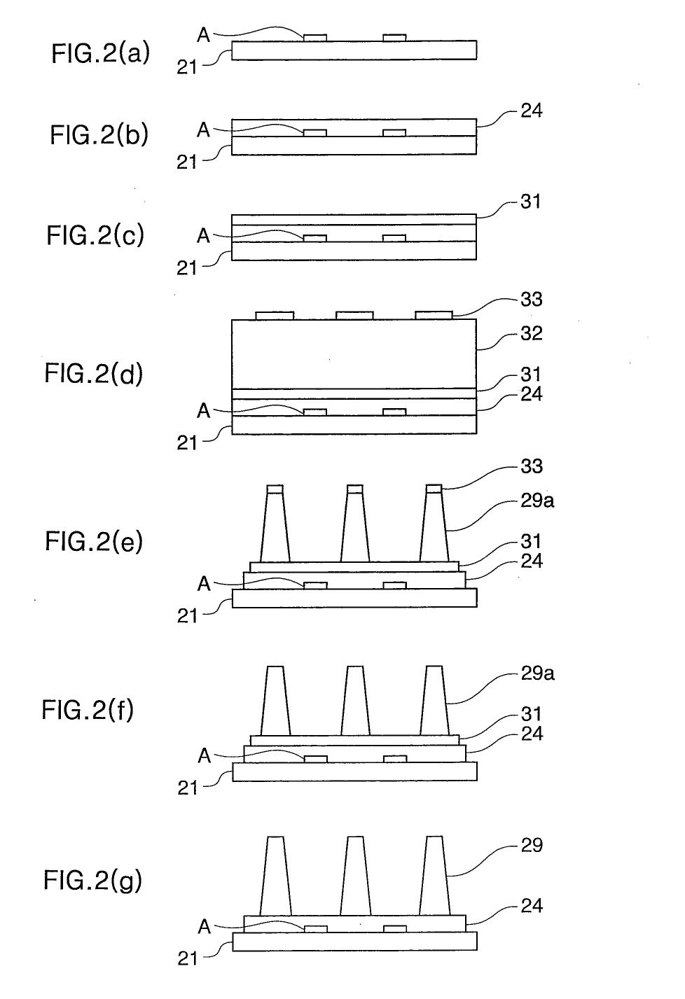

FIG. 2(a) to FIG. 2(g) are explanatory views that show the method of forming barrier ribs of the present invention in the order of processes. FIG. 2(a) shows a state in which address electrodes A are formed on the substrate 21 on the back face side. Moreover, FIG. 2(b) shows a state in which a second dielectric layer 24 made from low-melting-point lead glass is formed in a manner so as to cover the address electrodes A. These processes are the same as those of the conventional method.

Next, in the processes as shown in FIG. 2(c), based upon the feature of the present invention, a bonding layer 31 having a thermally burning-out property is formed on the second dielectric layer 24 that forms a barrier rib formation surface. This bonding layer 31 is formed by processes in which, for example, a resin solution, prepared by dissolving polyether sulfone that is a polyether-based resin in butyl carbitol, is evenly applied and dried to form a layer with a thickness of several microns, preferably, in a range from 1 to 10 μm. The exemplified polyether sulfone has a heat resistant property up to 200° C. at which the barrier rib material layer is dried in the post process, and also has a burning-out property at a temperature exceeding 500° C. at which the barrier rib patterning material layer is fired.

Various other resins are selectable as the resin having a burning-out property, which also has a heat resistant property up to a predetermined temperature. For example, polyimide-based resins, polycarbonate, poly-4-ethylene fluoride and polyphenylene sulfide may be used.

Next, in a process shown in FIG. 1(d), a low-melting-point glass paste to be formed into a barrier rib material layer when dried is applied onto the bonding layer 31 by using a screen printing process or the like with a thickness of, for example, 150 μm, corresponding to the height of the barrier ribs, and dried thereon at about 180° C. so that a barrier rib material layer 32 is formed. With respect to the low-melting point glass paste, a material may be used, which is formed by adding to be mixed therein lead oxide glass (PbO) and a reinforcing material (aggregate), such as alumina (Al₂O₃) and zirconia (ZrO₂), used for strengthening the structural body, to an organic substance, made from ethyl cellulose, an organic binder, an organic solvent and the like, to which a dispersant is added.

Moreover, a photosensitive resist film is affixed onto the barrier rib material layer 32, and this is subjected to exposing and developing processes through a photomask so that a resist mask 33 for a barrier rib pattern is formed. The photosensitive resist film may be formed by laminating a photosensitive dry film, or may be formed by applying a liquid-state resist to be dried thereon.

Thereafter, in a process shown in FIG. 2(e), the barrier rib material layer 32 is cut off by using a sand blasting process to be patterned into barrier ribs so that a barrier rib pattern material layer 29a is obtained.

Moreover, in a process shown in FIG. 2(f), a resist peeling liquid is poured onto the sand-blast processed surface like a shower so that the resist mask 33 is pelt off and removed.

In the peeling process of the resist mask 33 of the present embodiment, since the bonding layer 31 is designed so that the bonding strength between the barrier rib pattern material layer 29a and the second dielectric layer 24 is made to be greater than the peeling force of the resist mask 33 swelled by the peeling liquid, no collapse occurs in the barrier rib pattern material layer 29a. Therefore, it becomes possible to reduce the defective product rate of the panel. Moreover, even in the case when the width of the barrier ribs is made thinner, since the barrier rib pattern material layer is free from collapse, it is possible to manufacture a display panel with higher precision.

Lastly, in a process shown in FIG. 2(g), by firing the barrier rib pattern material layer 29a at a temperature of 560° C., sintered barrier ribs 29 are completed. In this firing process, since the bonding layer 31 is burned and eliminated together with a binder component and the like in the barrier rib material, it is possible to prevent the bonding layer 31 from giving adverse effects to the succeeding assembling process with the substrate on the front face side and the characteristics of the finished panel.

The above-mentioned embodiment has exemplified a structure in which low-melting-point lead glass is used as the second dielectric layer and low-melting-point lead glass is also used as the barrier rib material layer; however, the present invention is also effectively applied to another structure in which one or both of the layers are formed by non-lead glass, such as zinc-based (ZnO) glass.

In particular, in the case when both of the second dielectric layer and the barrier rib material layer are formed by zinc-based (ZnO) low-melting-point glass, a phenomenon occurs in which the bonding strength between the second dielectric layer and the barrier rib material layer becomes poorer than that in the case when both of those layers are formed by lead oxide-based (PbO) low-melting-point glass. Therefore, the effects of the present invention are exerted more remarkably when non-lead-based low-melting point glass is used for both of the second dielectric layer and the barrier rib material layer.

Moreover, in the present invention, not limited to low-melting-point glass, a thin film of silicon oxide (SiO₂), formed by a CVD method, may also be used as the second dielectric layer.

The above-mentioned embodiment has exemplified a structure in which a straight pattern is used as the barrier rib structure. In the case of the straight pattern (or a stripe pattern), since barrier ribs in the longitudinal direction are respectively independent, the resulting structure tends to easily collapse in a lateral direction so that the effects of the present invention are highly expected. However, even in the other structure, for example, a meander pattern barrier rib structure and a lattice-shaped pattern barrier rib structure, the present invention is effectively applied so that barrier ribs with high precision having a bottom width of 100 μm or less can be manufactured with a high yield.

In addition to the above-mentioned sand blasting method, a subtracting method, such as a wet-etching method, including a resist-peeling process may be applied to the present invention as the method of forming barrier ribs, and the same effects can be obtained.

Although the above-mentioned embodiment has exemplified an AC-type PDP, the present invention may also be applied to a DC-type PDP in the same manner.

The present invention can be utilized for manufacturing plasma display apparatuses of various types. For example, it can be widely utilized for manufacturing plasma display panels to be used as display apparatuses, such as personal computers and workstations, flat wall-type televisions, or apparatuses for displaying advertisements, information, etc.

What is claimed is:

1. A method of forming barrier ribs, comprising the steps of:
forming a barrier rib material layer on a substrate;
forming a resist film on the barrier rib material layer to pattern the resist film into a barrier rib pattern;
removing the barrier rib material layer corresponding to unnecessary portions by utilizing the patterned resist film, to form a barrier rib pattern material layer;
removing the resist film from the barrier rib pattern material layer; and
firing the barrier rib pattern material layer to form barrier ribs,
wherein a bonding layer is formed between the substrate and the barrier rib material layer, and
the bonding layer has such a bonding strength that sufficiently maintains the barrier rib pattern material layer on the substrate upon removing the resist film from the barrier rib pattern material, and is made from a thermally burning-out material which is burned out when the barrier rib pattern material layer is fired.

2. The method according to claim 1, wherein the bonding layer is made from a material mainly composed of a heat resistant resin which is not burned out at least up to 200° C.

3. The method according to claim 1, wherein the bonding layer is made from a material mainly composed of one or two or more kinds of synthetic resins selected from the group consisting of a polyether-based resin, a polyimide-based resin, polycarbonate, poly 4-ethylene fluoride and polyphenylene sulfide.

4. The method according to claim 2, wherein the bonding layer is made from a material mainly composed of one or two or more kinds of synthetic resins selected from the group consisting of a polyether-based resin, a polyimide-based resin, polycarbonate, poly 4-ethylene fluoride and polyphenylene sulfide.

5. The method according to claim 1, wherein the bonding layer has a thickness of 10 μm or less.

6. The method according to claim 1, wherein the barrier rib is formed with a thickness of 100 μm or less.

7. A method of forming barrier ribs of a plasma display panel, comprising the steps of:
forming a bonding layer which is burned out at a temperature exceeding 500° C., on a barrier rib forming surface of a substrate;
forming a barrier rib material layer on the bonding layer so that the barrier rib material layer is bonded to the barrier rib forming surface of the substrate by the bonding layer;
forming a barrier rib pattern mask which has openings formed into a pattern corresponding to a predetermined barrier rib shape, on the barrier rib material layer;
removing the barrier rib material layer exposed from the openings of the barrier rib pattern mask to form a barrier rib pattern material layer;
peeling off and removing the barrier rib pattern mask from the barrier rib pattern material layer; and
firing the barrier rib pattern material layer at a temperature of 500° C. or more so that the bonding layer is burned out and barrier ribs are formed.

8. The method according to claim 7, wherein the bonding layer is made from a material mainly composed of one or two or more kinds of synthetic resins selected from the group consisting of a polyether-based resin, a polyimide-based resin, polycarbonate, poly 4-ethylene fluoride and polyphenylene sulfide.
